(19) United States
(12) Patent Application Publication
(10) Pub. No.: US 2023/0009986 A1
(43) Pub. Date: Jan. 12, 2023

(54) A controller for function switching and dynamic identification switching and a dynamic identification method

(71) Applicant: SHENZHEN ONEBITDO TECH CO., LTD., Shenzhen, (CN)

(72) Inventor: Jingxing Chen, Shenzhen (CN)

(73) Assignee: SHENZHEN BESTODO TECH CO., LTD., Shenzhen (CN)

(21) Appl. No.: 17/275,194

(22) PCT Filed: Sep. 15, 2020
(86) PCT No.: PCT/CN2020/115261

§ 371 Date: Mar. 11, 2021

(30) Foreign Application Priority Data
Mar. 20, 2020 (CN) 202020361595.4
Aug. 20, 2020 (CN) 202010843747.9

(51) Int. Cl. A63F 13/22; A63F 13/215; A63F 13/235; A63F 13/533

(52) U.S. Cl. CPC A63F 13/22; A63F 13/215; A63F 13/235; A63F 13/533; A63F 2300/308; A63F 2300/1018; A63F 2300/1031; A63F 2300/1056; A63F 2300/1081

(57) ABSTRACT

A controller for function switching and dynamic identification switching and a dynamic identification method are disclosed. The controller includes a switch circuit, a master circuit and a switching circuit, wherein the switch circuit is electrically connected to the master circuit, and the switching circuit is electrically connected to the master circuit. The switching circuit includes a function realization component and a light controlled component, the function realization component is electrically connected to the master circuit for function realization, and the light controlled component is electrically connected to the master circuit for light conversion. When the function is switched, the corresponding dynamic identification is synchronously completed. It not only completes reliable function switching, but also timely and accurately identifies the dynamic change of functions, which is convenient for users.

### BACKGROUND OF THE INVENTION

### Field Of The Invention

The present invention relates to the field of game equipment, in particular to a controller for function switching and dynamic identification switching and a dynamic identification method.

### Description Of Related Art

In modern production and life, function switching is used in many aspects, such as function switching of game devices. Specifically, for example, mode functions of the game devices can be switched by a handle, and the user can realize conversion of different mode functions through selections according to the needs. Therefore, it is very important to efficiently and accurately control the corresponding circuits to realize the function switching according to the user’s choice. Only achieving efficient and accurate function switching still has the problem that users cannot know the state after switching in time. The game device is also taken as an example, when the mode function is switched, it is difficult for the user to know whether the switching is successful if there is no corresponding identification, and it is difficult for the user to know the mode state of the game device at this time. Thus, it is essential to carry out corresponding dynamic identification while realizing efficient function switching.

In addition, there are various styles of game devices on the market, which generally have dazzling and changeable game screens and sound effects. However, in the existing game devices, the game screen and sound effects are presented for the game content, while the operation methods of the user (such as button habit, button frequency, misoperation rate, etc.) are difficult to be effectively analyzed and directly reflected to the user. Without analysis of the user operations, it is difficult to understand user’s habits and needs. Since users lack the understanding of their own operating methods, it is difficult for them to further enhance the game experience. In summary, analysis, guidance and presentation of user’s operating methods are key points for enhancing the experience of game devices.

Therefore, in order to complete corresponding dynamic identification for facilitating the users when function switching is performed, there is an urgent need for providing a controller for function switching and dynamic identification switching and a method of how to effectively analyze and intuitively feedback operation modes of the users.

### SUMMARY OF THE INVENTION

In view of this, the present invention aims to solve the technical problems in the related art to a certain extent.

In order to achieve the above objective, a controller for function switching and dynamic identification switching is provided in the present invention, which includes a switch circuit, a master circuit and a switching circuit, wherein the switch circuit is electrically connected to the master circuit, and the switching circuit is electrically connected to the master circuit; the switching circuit includes a function realization component and a light controlled component, the function realization component is electrically connected to the master circuit for function realization, and the light controlled component is electrically connected to the master circuit for light conversion.

In the present invention, through provision of the switch circuit, the user may use buttons or other touch methods to select functions; through provision of the master circuit and connecting the switch circuit with the master circuit, the signal of the switch circuit may be easily transmitted to the master circuit; through provision of the switching circuit and connecting the master circuit with the switching circuit, the signal of the master circuit may be easily transmitted to the switching circuit. In the switching circuit, the function realization component is electrically connected to the master circuit, so that the signal of the master circuit may be easily transmitted to the function realization component, and the light controlled component is also electrically connected to the master circuit, so that the signal of the master circuit may be easily transmitted to light controlled component. Therefore, in the present invention, based on the electrical connection structure of the switch circuit, the master circuit and the switching circuit, the transmission of electrical signals is realized. When the user selects any function through the switch circuit, the electrical signal information triggered by the selected information is transmitted to the function realization component and the light controlled component in the switching circuit through the switch circuit and the master circuit, and the function realization component realizes accurate function conversion while the light controlled component achieving the effect of converting the corresponding identification. In summary, based on the controller structure of the present invention, in addition to meeting the functional requirements from the user, the current state is dynamically reminded for the user, so as to fully meet different needs of users and facilitate user’s operations.

Optionally, the switch circuit includes a power supply and a plurality of switch elements for forming a plurality of high-level and low-level input signals, wherein the plurality of switch elements are electrically connected to the power supply respectively, and the plurality of switch elements are electrically connected to the master circuit respectively.

Therefore, the power supply is connected to the switch element circuit, and the power supply provides power for the switch element, so that under the action of the current, different combinations of switch elements form different high-level and low-levels to trigger different electrical signals for inputting signals to the master circuit so as to prompt the master circuit to send control signals. Therefore, the power supply and the switch element of the switch circuit are connected to cooperate with each other to form an input signal, which is convenient for the user to select functions. The switch circuit includes a plurality of switch elements for forming different high-level and low-level input signals in cooperation with the power supply. Therefore, under the action of current, the plurality of switch elements form different switching combinations, and different high-level and low-levels are formed through different switching combinations, so as to input different electrical signals to the master circuit. Under the action of different control signals, a plurality of function switching and dynamic identification switching may be effectively completed.

Optionally, the master circuit includes a micro control unit, the micro control unit is electrically connected to the switch circuit through input signal pins, and the micro control unit is electrically connected to the switching circuit through output signal pins.

Optionally, the switch circuit includes a plurality of switch elements, and the micro control unit is connected to the plurality of switch elements through the input signal pins for receiving the plurality of high-level and low-level input signals formed by the plurality of switch elements.

Therefore, the input signal pins of the micro control unit are connected to the switch circuit for receiving the input signals of the switch circuit. The switch circuit inputs different high-level and low-level signals. Based on this, the master circuit outputs corresponding high-level and low-level output signals for triggering the switching circuit to switch different functions and perform corresponding dynamic identification, so as to efficiently process signals to meet user needs.

Optionally, the function realization component includes a plurality of operation elements, and the micro control unit is connected to different operation elements through different input signal pins for outputting different high-level and low-level input signals to the plurality of operation elements.

Optionally, the light controlled component includes a plurality of light elements, and the micro control unit is connected to different light elements through different input signal pins for outputting different high-level and low-level input signals to the plurality of light elements.

Therefore, under different output signals of the plurality of light elements, some light elements are turned on and some light elements are turned off to form different light and dark combinations, which dynamically identify different functions realized by multiple functional drive circuits, and achieve the purpose of promptly reminding users while switching function.

Optionally, based on different high-level and low-level signals input by the switch circuit, the master circuit outputs corresponding different high-level and low-level output signals to the switching circuit The high-level and low-level output signals are used to control the plurality of functional drive circuits to switch different functions, and are also used to control the plurality of light drive circuits to identify different functions implemented by the plurality of functional drive circuits.

Therefore, the switch circuit inputs different high-level and low-level input signals. Based on this, the master circuit outputs corresponding high-level and low-level signals, for triggering the switching circuit to switch different functions and perform corresponding dynamic identification, so as to effectively treat signals and meet the user’s requirements.

Optionally, the controller further includes a voice control circuit. The voice control circuit includes a voice control component, and the voice control component is electrically connected to the master circuit.

Optionally, the controller further includes a blue-tooth circuit electrically connected to the master circuit. The master circuit controls the switching circuit according to the input voice signal of the voice control component. The blue-tooth circuit includes a blue-tooth chip.

Optionally, the master circuit includes a micro control unit, and the micro control unit is electrically connected to different blue-tooth signal output pins of the blue-tooth chip through a plurality of input signal pins.

Another objective of the present invention is to provide a dynamic identification method to effectively analyze, guide and feedback user’s operations modes.

In order to achieve the above objective, the technical scheme of the present invention is achieved as follows.

A method for dynamic identification of a game device is disclosed, which includes: acquiring an operation signal, the operation signal including dynamic operation indicators formed by a user triggering operating hardware through a plurality of dynamic operations, the dynamic operation indicators including a frequency, a timing and a strength at which each of the operating hardware is triggered; recording and counting the dynamic operation indicators for performing a user operation analysis; and controlling a flicker frequency and/or a color and/or a brightness of the light controlled components corresponding to the operating hardware according to results of the user operation analysis to perform different light displays for feeding back the dynamic operating indicators corresponding to each of the operating hardware.

Therefore, in the present invention, the operation of the user is recorded and analyzed to understand the operation method of the user. The display of the light controlled component is used for intuitive presentation, which allows the user to more clearly understand their own operation mode, so as to further optimize and improve the convenience of the user.

Optionally, the results of the user operation analysis include an analysis result of the frequency at which each of the operating hardware is triggered, and the step of controlling the flicker frequency and/or the color and/or the brightness of the light controlled components corresponding to the operating hardware according to results of the user operation analysis to perform different light displays includes: controlling the flicker frequency of the light controlled components corresponding to the operating hardware according to the analysis result of the frequency at which each of the operating hardware is triggered to perform different flicker displays, wherein the flicker frequency of each of the light controlled components is used to feed back the frequency at which the corresponding operating hardware is triggered.

Optionally, during the process of performing different flicker displays, changes of an external ambient light are sensed, and the brightness and/or the color of the light controlled components are automatically adjusted to meet requirements of human eyes.

Optionally, the dynamic identification method of the game device further includes: controlling a terminal to perform further comprehensive data analysis on the dynamic operation indicators of all the operating hardware and determining a plurality of user content data reflecting user operation habits according to the results of the user operation analysis, and displaying the plurality of user content data on a display component of the terminal.

Optionally, the step of controlling a terminal to perform further comprehensive data analysis on the dynamic operation indicators of all the operating hardware and determining a plurality of user content data reflecting user operation habits according to the results of the user operation analysis includes: acquiring statistical data of the dynamic operation indicators corresponding to each of the operating hardware in the results of the user operation analysis; and performing comprehensive analysis according to the statistical data to determine the plurality of user content data reflecting the user operation habits, wherein the comprehensive analysis includes a user operation frequency analysis, a combined operation analysis, a conventional operation analysis and a misoperation analysis.

Optionally, the operation signal further includes a game mode indicator selected by the user by triggering the operating hardware, and the dynamic identification method of the game device further includes: determining a corresponding key position mode according to the game mode indicator; determining the operating hardware required in the key position mode according to the key position mode; and controlling the flicker frequency and/or the color and/or the brightness of the light controlled components corresponding to the operating hardware required in the key position mode to perform different light displays for identifying the operating hardware required to be triggered in the key position mode.

Optionally, the operation signal further includes a confirmation storage instruction formed by the user by triggering the operating hardware, and the dynamic identification method of the game device further includes: entering and storing user preference operations according to the confirmation storage instruction, wherein the user preference operations include a key layout formed by triggering the operating hardware after the confirmation storage instruction is issued by the user, and/or a key layout set by the display component of the terminal after the confirm storage instruction is issued by the user.

Optionally, the operation signal further includes a guiding demand instruction formed by the user by triggering the operating hardware, and the dynamic identification method of the game device further includes: determining a content requirement of the user to guide a game mode according to the guiding demand instruction; and controlling the flicker frequency and/or the color and/or the brightness of the light controlled components corresponding to the operating hardware required to be triggered at a current moment and/or controlling the display component of the terminal for screen displays according to the content requirement to identify the operating hardware required to be triggered at the current moment, and performing corresponding operation information return, confirmation and entering subsequent programs.

Optionally, the dynamic identification method of the game device further includes: acquiring and analyzing a game content; and adjusting the flicker frequency and/or the color and/or the brightness of the light controlled component according to analysis results of the game content to perform the light displays for enhancing a game atmosphere.

Optionally, the dynamic identification method further includes: acquiring a power value of a system to which the operating hardware belongs; and adjusting the flicker frequency and/or the color and/or the brightness of the light controlled component to perform the light displays if the power value has triggered a low power mode to warn the user about the power.

To achieve the above objective, a computer-readable storage medium storing one or more instructions which, when executed by one or more processors of an electronic device, executes a dynamic identification method applied to the above-mentioned controller for function switching and dynamic identification switching, wherein the method includes: acquiring an operation signal, the operation signal including dynamic operation indicators formed by a user triggering operating hardware through a plurality of dynamic operations, the dynamic operation indicators including a frequency, a timing and a strength at which each of the operating hardware is triggered; recording and counting the dynamic operation indicators for performing a user operation analysis; and controlling a flicker frequency and/or a color and/or a brightness of the light controlled components corresponding to the operating hardware according to results of the user operation analysis to perform different light displays for feeding back the dynamic operating indicators corresponding to each of the operating hardware.

The computer-readable storage medium has the same beneficial effects as the above-mentioned dynamic identification method over the prior art, and detailed description is omitted herein.

### BRIEF DESCRIPTION OF THE DRAWINGS

Aspects of the present invention are best understood from the following detailed description when read with the accompanying figures. The exemplary embodiments of the present invention and the description thereof are used to explain the present invention, and do not constitute improper limitations on the preset invention. In the drawings:

FIG. 1 is a first block diagram of a controller for function switching and dynamic identification switching according to an embodiment of the present invention.

FIG. 2 is a first specific structural diagram of a controller for function switching and dynamic identification switching according to an embodiment of the present invention.

FIG. 3 is a second specific structural diagram of a controller for function switching and dynamic identification switching according to an embodiment of the present invention.

FIG. 4 is a third specific structural diagram of a controller for function switching and dynamic identification switching according to an embodiment of the present invention.

FIG. 5 is a fourth specific structural diagram of a controller for function switching and dynamic identification switching according to an embodiment of the present invention.

FIG. 6 is a fifth specific structural diagram of a controller for function switching and dynamic identification switching according to an embodiment of the present invention.

FIG. 7 is a sixth specific structural diagram of a controller for function switching and dynamic identification switching according to an embodiment of the present invention.

FIG. 8 is a seventh specific structural diagram of a controller for function switching and dynamic identification switching according to an embodiment of the present invention.

FIG. 9 is an eighth specific structural diagram of a controller for function switching and dynamic identification switching according to an embodiment of the present invention.

FIG. 10 is a ninth specific structural diagram of a controller for function switching and dynamic identification switching according to an embodiment of the present invention.

FIG. 11 is a tenth specific structural diagram of a controller for function switching and dynamic identification switching according to an embodiment of the present invention.

FIG. 12 is an eleventh specific structural diagram of a controller for function switching and dynamic identification switching according to an embodiment of the present invention.

FIG. 13 is a twelfth specific structural diagram of a controller for function switching and dynamic identification switching according to an embodiment of the present invention.

FIG. 14 is a second block diagram of a controller for function switching and dynamic identification switching according to an embodiment of the present invention.

FIG. 15 is a first flow chart of a dynamic identification method of a game device according to an embodiment of the present invention.

FIG. 16 is a second flow chart of a dynamic identification method of a game device according to an embodiment of the present invention.

FIG. 17 is a flow chart of a terminal analysis according to an embodiment of the present invention.

FIG. 18 is a third flow chart of a dynamic identification method of a game device according to an embodiment of the present invention.

FIG. 19 is a fourth flow chart of a dynamic identification method of a game device according to an embodiment of the present invention.

FIG. 20 is a fifth flow chart of a dynamic identification method of a game device according to an embodiment of the present invention.

FIG. 21 is a sixth flow chart of a dynamic identification method of a game device according to an embodiment of the present invention.

### DESCRIPTION OF THE PREFERRED EMBODIMENTS

In order to enable the above objects, features and advantages of the disclosure to be more apparent and easily understood, the specific embodiments of the disclosure will be further elaborated hereafter in connection with the drawings.

For a single control circuit, the switching function may be controlled by using a clutch to engage and disconnect. However, practical applications often need to control multiple function switching, and the realization of different function switching through different circuit combinations puts forward high requirements on how to realize high-efficiency function switching control. Only achieving efficient and accurate function switching still has the problem that users cannot know the state after the operating device is switched in time. For example, the function switching of game device, specifically, the mode function of the game device is switched by the handle. Only achieving efficient and accurate function switching still has the problem that users cannot know the state after switching in time. When the mode function is switched, it is difficult for the user to know whether the switching is successful if there is no corresponding identification, and it is difficult for the user to know the mode state of the game device at this time. Thus, it is essential to carry out corresponding dynamic identification while realizing efficient function switching. The present invention provides a controller for function switching and dynamic identification switching aiming at the problem of how to implement corresponding dynamic identification while realizing efficient function switching.

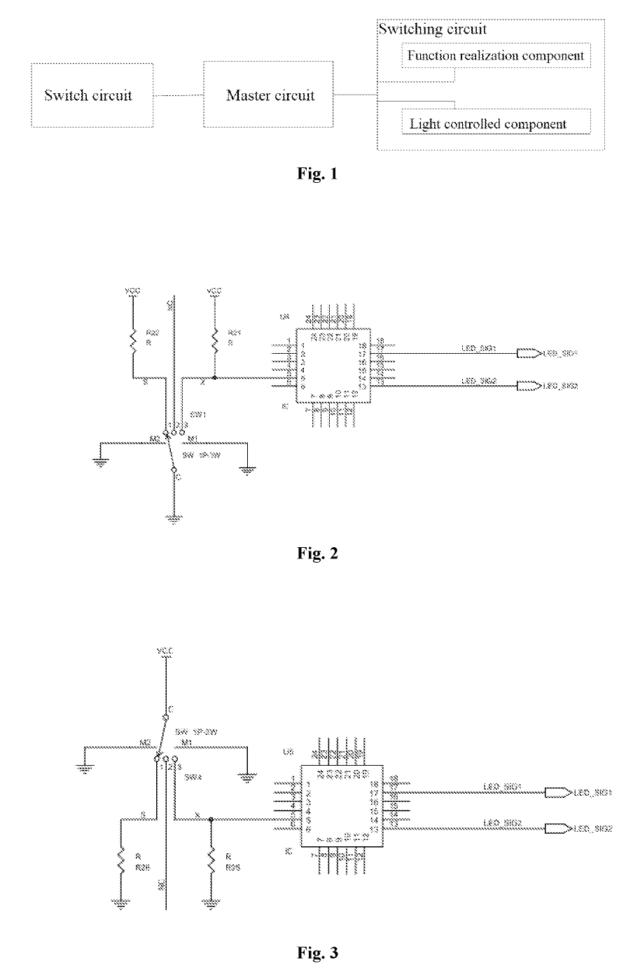

An embodiment of the present invention provides a controller for function switching and dynamic identification switching. FIG. 1 is a first block diagram of a controller for function switching and dynamic identification switching according to an embodiment of the present invention. With reference to FIG. 1, the controller for function switching and dynamic identification switching according to an embodiment of the present invention includes a switch circuit, a master circuit and a switching circuit, wherein the switch circuit is electrically connected to the master circuit, and the switching circuit is electrically connected to the master circuit. The switching circuit includes a function realization component and a light controlled component, wherein the function realization component is electrically connected to the master circuit for function realization, and the light controlled component is electrically connected to the master circuit for light conversion. In the present invention, through provision of the switch circuit, the user may use buttons or other touch methods to select functions; through provision of the master circuit and connecting the switch circuit with the master circuit, the signal of the switch circuit may be easily transmitted to the master circuit; through provision of the switching circuit and connecting the master circuit with the switching circuit, the signal of the master circuit may be easily transmitted to the switching circuit. In the switching circuit, the function realization component is electrically connected to the master circuit, so that the signal of the master circuit may be easily transmitted to the function realization component, and the light controlled component is also electrically connected to the master circuit, so that the signal of the master circuit may be easily transmitted to light controlled component. Therefore, in the present invention, based on the electrical connection structure of the switch circuit, the master circuit and the switching circuit, the transmission of electrical signals is realized. When the user selects any function through the switch circuit, the electrical signal information triggered by the selected information is transmitted to the function realization component and the light controlled component in the switching circuit through the switch circuit and the master circuit, and the function realization component realizes accurate function conversion while the light controlled component achieving the effect of converting the corresponding identification. In summary, based on the controller structure of the present invention, in addition to meeting the functional requirements from the user, the current state is dynamically reminded for the user, so as to fully meet different needs of users and facilitate user’s operations.

Optionally, the switch circuit includes a power supply and a plurality of switch elements for forming a plurality of high-level and low-level input signals, wherein the plurality of switch elements are electrically connected to the power supply respectively, and the plurality of switch elements are electrically connected to the master circuit respectively. Therefore, the power supply is connected to the switch elements, and the power supply provides power for the switch element, so that under the action of the current, different combinations of switch elements form different high-level and low-levels to trigger different electrical signals for inputting signals to the master circuit so as to prompt the master circuit to send control signals. Therefore, the power supply and the switch element of the switch circuit are connected to cooperate with each other to form an input signal, which is convenient for the user to select functions. The switch circuit includes a plurality of switch elements for forming different high-level and low-level input signals in cooperation with the power supply. Therefore, under the action of current, the plurality of switch elements form different switching combinations, and different high-level and low-levels are formed through different switching combinations, so as to input different electrical signals to the master circuit. Under the action of different input electrical signals, the master circuit is prompted to send different control signals. Under the action of different control signals, a plurality of function switching may be effectively completed.

Optionally, the master circuit includes a micro control unit, the micro control unit is electrically connected to the switch circuit through an input signal pin, and the micro control unit is electrically connected to the switching circuit through output signal pins. Therefore, in the master circuit, the input signal pins of the micro control unit are connected to the switch circuit for receiving the input signals of the switch circuit. Under the influence of the input signal, the master circuit sends the corresponding output signals to meet the user’s need for function switching. In the master circuit, output signal pins of the micro control unit are connected to the switching circuit, and the switching circuit switches different modes according to the output signals to realize different functions when the micro control unit sends the output signals, so as to meet the user’s need for function switching and dynamic identification requirements.

Optionally, the switch circuit includes a plurality of switch elements, and the micro control unit is connected to the plurality of switch elements through different input signal pins for receiving different high-level and low-level input signals formed by the switch elements. Therefore, in the master circuit, the input signal pins of the micro control unit are connected to the switch circuit for receiving the input signals of the switch circuit, and the switch circuit outputs different high-level and low-level signals, based on which the master circuit outputs corresponding high-level and low-level signals to trigger the switching circuit to switch different functions and perform corresponding dynamic identification, so as to effectively treat signals and meet the user’s requirements.

Optionally, the function realization component includes a plurality of operation elements, and the micro control unit is connected to different operation elements through different input signal pins for outputting different high-level and low-level input signals to the plurality of operation elements. Therefore, for the plurality of operation elements, under different output signals, some operation element circuits are turned on and some operation element circuits are turned off to form different functional combinations, so as to meet the user’s multiple functional requirements and facilitate the user’s function switching.

Optionally, the light controlled component includes a plurality of light elements, and the micro control unit is connected to different light elements through different input signal pins for outputting different high-level and low-level input signals to the plurality of light elements. Therefore, under different output signals of the plurality of light elements, some light elements are turned on and some light elements are turned off to form different light and dark combinations, which dynamically identify different functions realized by multiple functional drive circuits, and achieve the purpose of promptly reminding users while switching function.

FIG. 2 is a first specific structural diagram of a controller for function switching and dynamic identification switching according to an embodiment of the present invention. With reference to FIG. 2, the controller for function switching and dynamic identification switching includes a switch circuit, a master circuit and a switching circuit. In the switch circuit, VCC represents the power supply, which is connected to a first switch element 1, a second switch element 2 and a third switch element 3 through a resistor R22 and a resistor R21, wherein in the switch element circuit, the symbols 1, 2, and 3 respectively represent the first switch element, the second switch element and the third switch element, with one terminal connected to the master circuit through the input signal pin and the other end grounded. In the switching circuit, there are two light circuits, LED-SIG1 and LED-SIG2, which are connected to the master circuit through the output signal pins. When switching to 1 and 3, the high-level and low-level signals of the IO port of the micro control unit are respectively given, the on and off mode of the output LED light is switched according to the software setting, for example: high-level represents that LED-SIG1 is on while LED-SIG2 is off, low-level represents that LED-SIG1 is off while LED-SIG2 is on, etc. The NC of the second switch element represents a pin floating or connected to other module circuits of the system. In an embodiment of the present invention, a setting is as follows according to the program of the micro control unit: when the first switch element is off, the micro control unit receives a high-level control signal and outputs high-level to LED-SIG1 and low-level to LED-SIG2. When the second switch element is off, the system is powered off and shut down. When the third switch element is off, the micro control unit receives a low-level control signal and outputs low-level to LED-SIG1 and high-level to LED-SIG2. The high-level and low-level of the LED-SIG signal may control ON/OFF or OFF/ON of the LED-SIG1 light circuit, with a logic relationship determined by the design of the peripheral PCB circuit and applied variously in different scenarios. It is realized with the cooperation of circuit design, software system and structure to achieve the effect that the user selects any function and then converts the corresponding identification.

In a specific embodiment of the present invention, it may be configured as: inactivation of the first switch element 1 corresponds to activation of the first function mode, inactivation of the second switch element 2 corresponds to activation of the second function mode, and inactivation the third switch element 3 corresponds to activation of the third function mode. If the first switch element 1 is switched, a high-level signal is input to the corresponding pin of the micro control unit of the master circuit, and the high-level and low-level output signals are output to the function realization component through the output signal pins to turn on the first function mode while transmitting the high-level and low-level output signals to the light controlled component LED-SIG2 so that the LED-SIG2 is turned on, which indicates that the system has switched to the first mode function.

FIG. 3 is a second specific structural diagram of a controller for function switching and dynamic identification switching according to an embodiment of the present invention. With reference to FIG. 3, the controller for function switching and dynamic identification switching includes a switch circuit, a master circuit and a switching circuit. In the switch circuit, VCC represents the power supply, which is connected to a first switch element 1, a second switch element 2 and a third switch element 3 through a resistor R25 and a resistor R26. In the switch element circuit, symbols 1, 2, and 3 respectively represent the first switch element, the second switch element and the third switch element, with one terminal connected to the master circuit through the input signal pin and the other end grounded. In the switching circuit, there are two light circuits, LED-SIG1 and LED-SIG2, which are connected to the master circuit through the output signal pins. When switching to 1 and 3, the high-level and low-level signals of the IO port of the micro control unit are respectively given, the on and off mode of the output LED light is switched according to the setting, for example: high-level represents that LED-SIG1 is on while LED-SIG2 is off, low-level represents that LED-SIG1 is off while LED-SIG2 is on, etc. Optionally, the NC of the second switch element represents a pin floating or connected to other module circuits of the system.

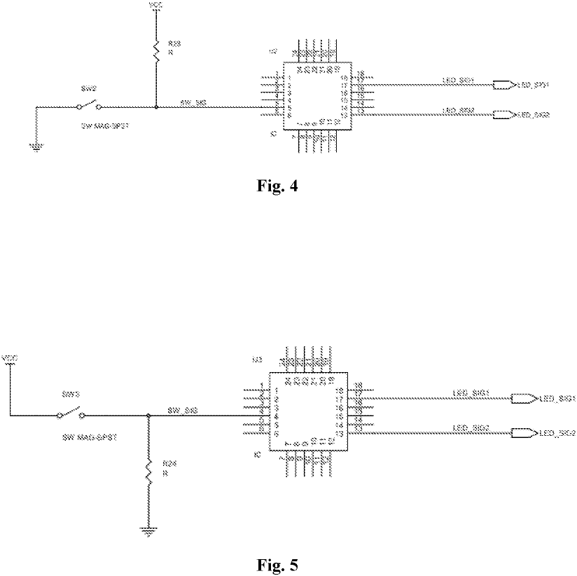

FIG. 4 is a third specific structural diagram of a controller for function switching and dynamic identification switching according to an embodiment of the present invention. With reference to FIG. 4, the controller for function switching and dynamic identification switching includes a switch circuit, a master circuit and a switching circuit. In the switch circuit, VCC represents the power supply, which is connected to a switch element SW2 through a resistor R23. In the switch element circuit, symbol SW2 represents the switch element connected to the master circuit through the input signal pins. In the switching circuit, there are two light circuits, LED-SIG1 and LED-SIG2, which are connected to the master circuit through the output signal pins. When the switch element SW2 is off, the high-level and low-level signals of the IO port of the micro control unit are respectively given, the on and off mode of the output lights is switched according to the software setting, for example: high-level represents that LED-SIG1 is on while LED-SIG2 is off, low-level represents that LED-SIG1 is off while LED-SIG2 is on.

FIG. 5 is a fourth specific structural diagram of a controller for function switching and dynamic identification switching according to an embodiment of the present invention. With reference to FIG. 5, the controller for function switching and dynamic identification switching includes a switch circuit, a master circuit and a switching circuit. In the switch circuit, VCC represents the power supply, which is connected to a switch element SW3 through a resistor R24. In the switch element circuit, symbol SW2 represents the switch element connected to the master circuit through the input signal pins. In the switching circuit, there are two light circuits, LED-SIG1 and LED-SIG2, which are connected to the master circuit through the output signal pins. When the switch element SW2 is off, the high-level and low-level signals of the IO port of the micro control unit are respectively given, the on and off mode of the output LED light is switched according to the software setting, for example: high-level represents that LED-SIG1 is on while LED-SIG2 is off, low-level represents that LED-SIG1 is off while LED-SIG2 is on. Optionally, the controller for function switching and dynamic identification switching further includes a voice control circuit including a voice control component and a power supply. The voice control component is electrically connected to the power supply, and the voice control component is electrically connected to the master circuit. Therefore, in the present invention, the voice control circuit is provided to facilitate the user to use the voice control mode to select functions, and the voice information is collected through the voice control circuit and transmitted to the master circuit as different input signals. Therefore, the voice control circuit and the switch circuit cooperate with each other, so that the user may select functions in a variety of ways to further realize efficient function switching. Optionally, the master circuit includes the micro control unit, and the micro control unit is electrically connected to the voice control component through the input signal pins. Thus, in the present invention, by electrically connecting the micro control unit to the voice control component, the micro control unit effectively receives the sound information of the voice control component, which is convenient for the user to use the voice control method for selection and input. In the present invention, the voice control circuit is provided to facilitate the user to use the voice control mode to select functions, and the voice information is collected through the voice control circuit and transmitted to the master circuit as different input signals. Therefore, the voice control circuit and the switch circuit cooperate with each other, so that the user may select functions in a variety of ways to further realize efficient function switching.

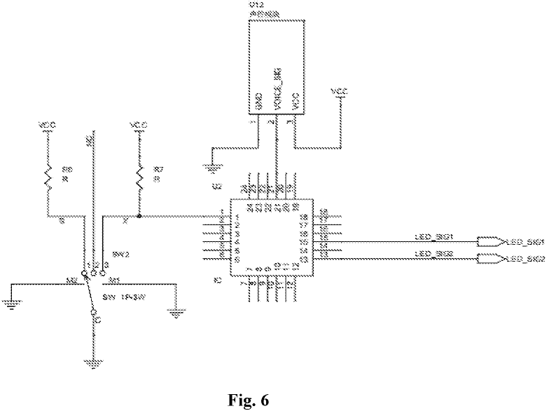

FIG. 6 is a fifth specific structural diagram of a controller for function switching and dynamic identification switching according to an embodiment of the present invention. With reference to FIG. 6, the controller for function switching and dynamic identification switching according to an embodiment of the present invention includes the switch circuit, the master circuit, the switching circuit, and the voice control circuit, wherein the switch circuit is electrically connected to the master circuit, the switching circuit is electrically connected to the master circuit, and the voice control circuit is electrically connected to the master circuit. In the voice control circuit, the voice control component and the voice control power supply are included. In the switch circuit, VCC represents the power supply, which is connected to a first switch element 1, a second switch element 2 and a third switch element 3 through a resistor R6 and a resistor R7. In the switch element circuit, symbols 1, 2, and 3 respectively represent the first switch element, the second switch element and the third switch element, with one terminal connected to the master circuit through the input signal pins and the other terminal grounded. In the switching circuit, there are two light circuits, LED-SIG1 and LED-SIG2, which are connected to the master circuit through the output signal pins. In the voice control circuit, the power supply VCC is connected to the voice control component, and the voice control component has one terminal grounded and one terminal connected to the master circuit through the pin of the micro control unit. The voice control circuit and the switch circuit are connected to the input signal pins of the master circuit and cooperate with each other, so that the user may not only switch the light function through the switch action, but also control the switch light function through the sound signal, which further facilitates the user.

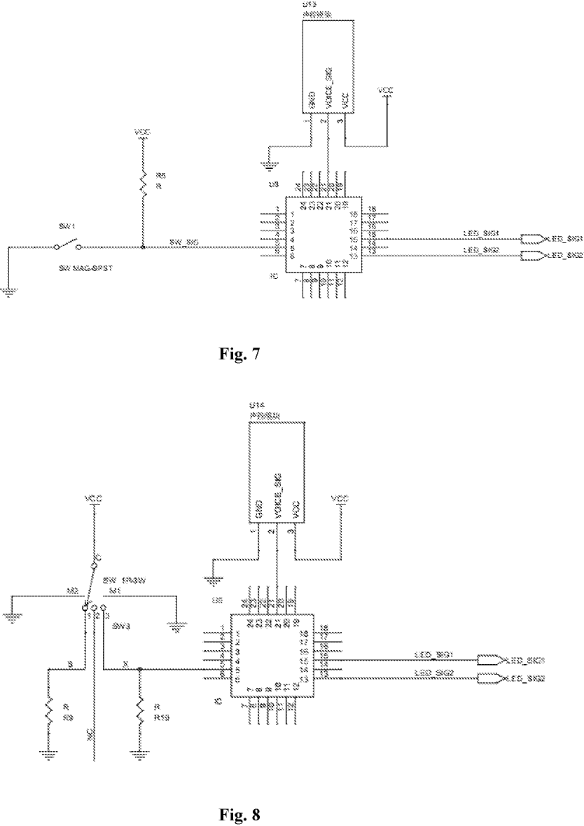

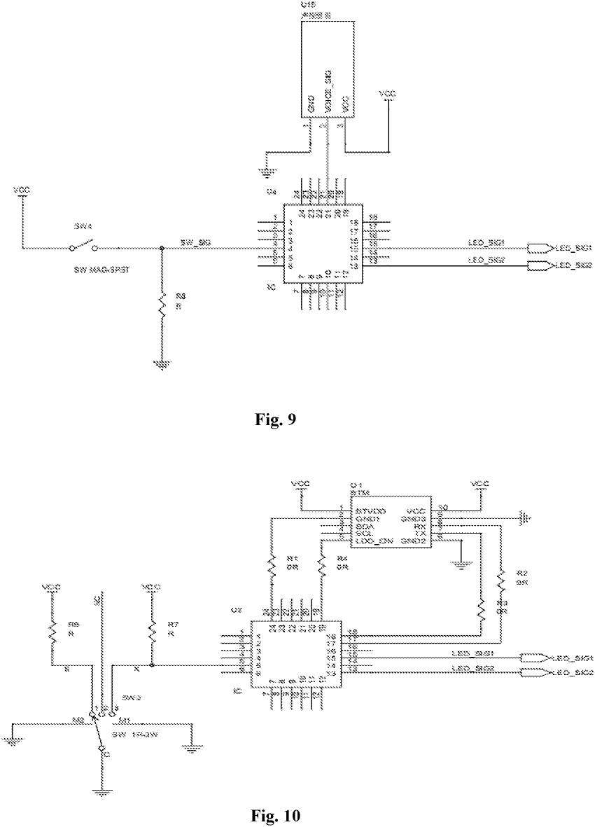

FIG. 7 is a sixth specific structural diagram of a controller for function switching and dynamic identification switching according to an embodiment of the present invention. FIG. 8 is a seventh specific structural diagram of a controller for function switching and dynamic identification switching according to an embodiment of the present invention. FIG. 9 is an eighth specific structural diagram of a controller for function switching and dynamic identification switching according to an embodiment of the present invention. FIGS. 7, 8 and 9 are examples of adding voice control circuits, and the connection method of the voice control circuit is the same as that of FIG. 6, but the connection methods of the switch circuit are different. Please refer to the specific description of FIGS. 3, 4 and 5, which will not be repeated here. Optionally, the controller for function switching and dynamic identification switching further includes a blue-tooth circuit, the blue-tooth circuit being electrically connected to the master circuit, the master circuit controlling the switching circuit according to the input sound signal of the voice control circuit, wherein the blue-tooth circuit includes a blue-tooth chip and a power supply. Therefore, in the present invention, the blue-tooth circuit is provided to facilitate the user to use various clients to select functions with in a manner of blue-tooth, and the user selection information is collected through the blue-tooth circuit and transmitted to the master circuit as different input signals. Therefore, the blue-tooth circuit and the switch circuit may cooperate with each other, so that the user may select functions in a variety of ways to further realize efficient function switching. Optionally, the master circuit includes a micro control unit, and the micro control unit is electrically connected to a plurality of blue-tooth signal output pins of the blue-tooth chip through a plurality of input signal pins. In the present invention, by electrically connecting the micro control unit to the blue-tooth chip, the micro control unit effectively receives the blue-tooth information of the blue-tooth chip, which is convenient for the user to use the blue-tooth method for selection and input. Therefore, in the present invention, the blue-tooth circuit is provided to facilitate the user to use various clients to select functions with in a manner of blue-tooth, and the user selection information is collected through the blue-tooth circuit and transmitted to the master circuit as different input signals. Therefore, the blue-tooth circuit and the switch circuit may cooperate with each other, so that the user may select functions in a variety of ways to further realize efficient function switching.

FIG. 10 is a ninth specific structural diagram of a controller for function switching and dynamic identification switching according to an embodiment of the present invention. With reference to FIG. 7, the controller for function switching and dynamic identification switching according to an embodiment of the present invention includes the switch circuit, the master circuit, the switching circuit, and the blue-tooth circuit, wherein the switch circuit is connected to the master circuit, the switching circuit is connected to the master circuit, and the blue-tooth circuit is connected to the master circuit. In the switch circuit, VCC represents the power supply, which is connected to a first switch element 1, a second switch element 2 and a third switch element 3 through a resistor R6 and a resistor R7. In the switch element circuit, symbols 1, 2, and 3 respectively represent the first switch element, the second switch element and the third switch element, with one terminal connected to the master circuit through the input signal pins and the other terminal grounded. In the switching circuit, there are two light circuits, LED-SIG1 and LED-SIG2, which are connected to the master circuit through the output signal pins. In the blue-tooth circuit, the blue-tooth chip and the power supply are included. The power supply VCC is connected to the blue-tooth chip through pins, and the blue-tooth chip has a plurality of pins grounded. Four pins of the blue-tooth chip are each electrically connected to the micro control unit of the master circuit through resistors R1, R2, R3, and R4 to input blue-tooth signals. The blue-tooth circuit and the switch circuit are connected to the input signal pins of the master circuit and cooperate with each other, so that the user may not only switch the light function through the switch action, but also control to switch light functions through the blue-tooth signal, which further facilitates the user.

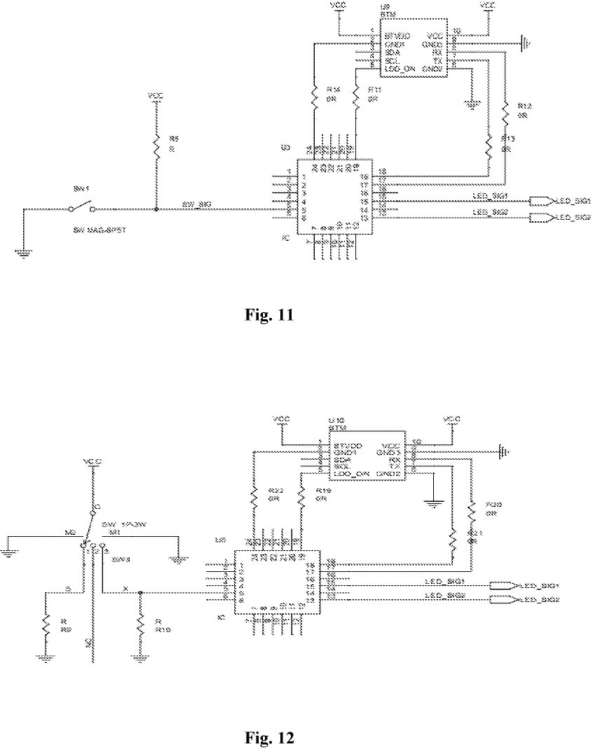

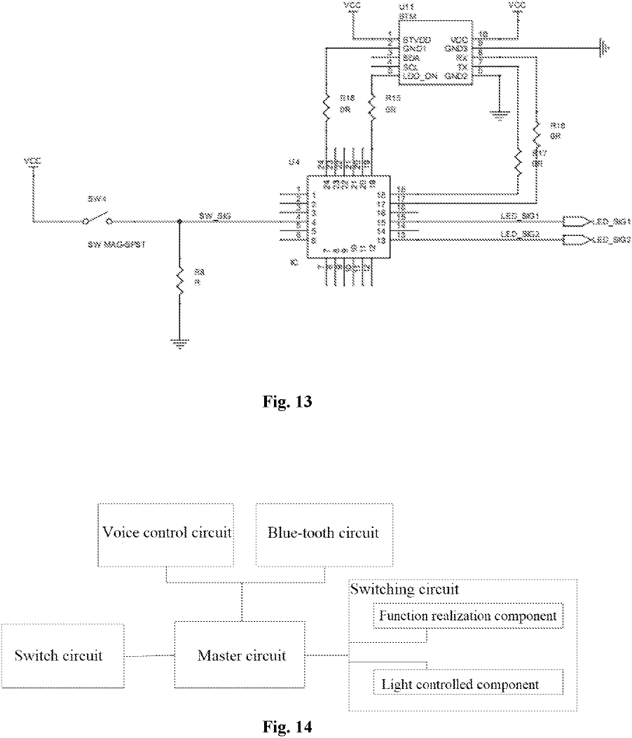

FIG. 11 is a tenth specific structural diagram of a controller for function switching and dynamic identification switching according to an embodiment of the present invention. FIG. 12 is an eleventh specific structural diagram of a controller for function switching and dynamic identification switching according to an embodiment of the present invention. FIG. 13 is a twelfth specific structural diagram of a controller for function switching and dynamic identification switching according to an embodiment of the present invention. FIGS. 11, 12 and 13 are examples of adding blue-tooth circuits, and the connection method of the blue-tooth circuit is the same as that of FIG. 10, but the connection methods of the switch circuit are different, please refer to the specific description of FIGS. 3, 4 and 5, which will not be repeated here.

FIG. 14 is a second block diagram of a controller for function switching and dynamic identification switching according to an embodiment of the present invention. With reference to FIG. 14, the controller for function switching and dynamic identification switching according to an embodiment of the present invention includes the switch circuit, the master circuit, the switching circuit, the voice control circuit and the blue-tooth circuit, wherein the switch circuit is connected to the master circuit, the switching circuit is connected to the master circuit, the voice control circuit is connected to the master circuit and the blue-tooth circuit is connected to the master circuit. Therefore, the blue-tooth circuit, the switch circuit and the voice control circuit are connected to the input signal pins of the master circuit and cooperate with each other to enable the user to switch functions through a variety of input signals. Optionally, the micro control unit selects the F1 series of STM32 or the F1 series of GD32. Therefore, in the present invention, the micro control unit of the F1 series of STM32 or the F1 series of GD32 is selected, based on a 32-bit microcontroller with ARM Cortex M3 core, to efficiently process data, send control signals quickly and accurately, complete various function switching, and quickly meet the needs of users for multiple function switching.

In summary, in the present invention, based on the mutual cooperation of the switch circuit, the master circuit and the switching circuit, the electrical signal of the switch circuit is transmitted to the function realization component and the component of the switching circuit to achieve the effect that the user selects any function, i.e., to switch the corresponding identification, so as to fully meet the different needs of the user. The user selects functions or controls circuit switches through buttons or other touch methods, selects the switching of function modes and the dynamic synchronous switching of corresponding function identifications, so as to solve the problem that users need multiple modes to coexist and switch at will, and the problem that the corresponding identification may not be changed at the same time when the function is switched, thereby achieving the effect that the user selects any function and then the corresponding identification is converted.

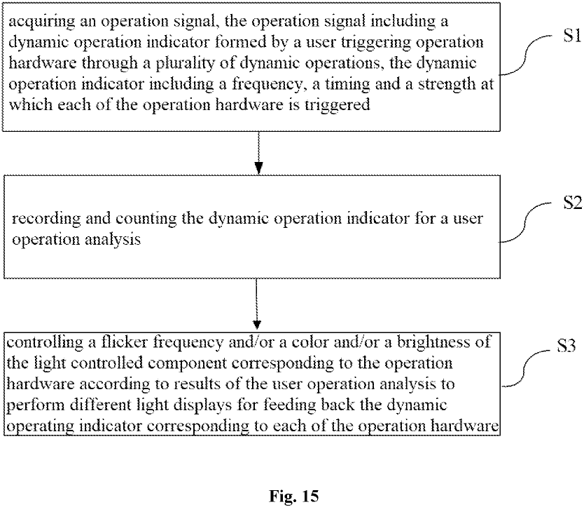

An embodiment of another aspect of the present invention provides a dynamic identification method of a game device. With reference to FIG. 15, FIG. 15 is a first flow chart of a dynamic identification method of a game device according to an embodiment of the present invention, which includes steps S1 to S3.

In the step S1, an operation signal is acquired, the operation signal including a dynamic operation indicator formed by a user triggering operating hardware 101 through a plurality of dynamic operations, wherein the dynamic operation indicator includes a frequency, a timing and a strength at which each of the operating hardware 101 is triggered. Therefore, the user operation mode may be understood through operation signal. Optionally, the operating hardware 101 includes buttons, and the dynamic operation indicator is formed by acquiring changes in physical quantity generated when the user triggers buttons, wherein changes in the pressure of the user pressing the buttons and changes in the pressing frequency are the physical quantities converted from the user operation. The generated changes in the pressure and the pressing frequency are used as analysis data, and then converted into electrical signals, which are transmitted through circuit communication. It can be understood that the operating hardware 101 is not limited to buttons (also including virtual buttons, virtual switches, etc.), as long as it can accurately recognize the user’s operation intention, and voice control, gesture recognition, etc. are not excluded. In an embodiment of the present invention, changes in the physical quantity include, but not limited to, changes in pressure, changes in light sense, and changes in sound sense. The process of collecting changes in physical quantity generally adopts node communication, and collecting the data content collected by some of the sensors is not collecting in full time. The data content is collected and transmitted by single excitation node for accurate collection of the data. Optionally, whether an operation signal is required to be acquired is determined before the operation signal is acquired. The user selects whether to acquire the operation signal according to the button or other identification carrier realized by the hardware and software defined by the system. When the user chooses to take the operation signal, the operation signal is started to be acquired, and optional analysis and control are performed. Therefore, the users may determine whether they need to analyze their own operation mode by triggering hardware or other methods. This function is optional. For users without analysis requirements, it will not cause excessive use.

In the step S2, the dynamic operation indicator for a user operation analysis is recorded and counted. Therefore, the operation of the user is recorded and analyzed to understand the operation method of the user.

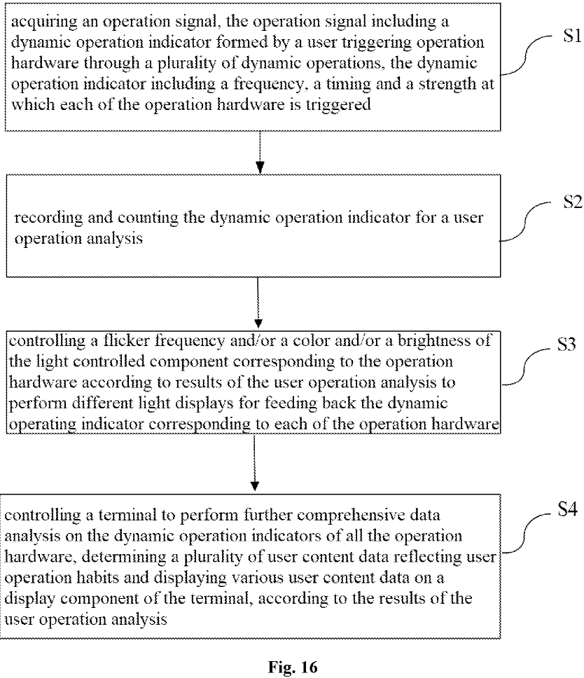

In the step S3, a flicker frequency and/or a color and/or a brightness of the light controlled component 102 corresponding to the operating hardware 101 is controlled according to results of the user operation analysis to perform different light displays for feeding back the dynamic operating indicator corresponding to each of the operating hardware 101. Therefore, in the present invention, the operation of the user is recorded and analyzed to understand the operation method of the user, and using the display of the light controlled component 102 for intuitive presentation allows the user to more clearly understand their own operation mode, so as to further optimize and improve the convenience of the user. Optionally, the light controlled component 102 includes components that may perform optical display such as light components, electronic screen components, etc., which are not limited to controlled components such as lights, magnetic induction, flexible screens or ink screens, as long as the corresponding optical display may be performed under control. Optionally, the results of the user operation analysis include results of a frequency analysis at which each of the operating hardware 101 is triggered. The step S3 specifically includes: controlling the flicker frequency of the light controlled component 102 corresponding to each of the operating hardware 101 according to the results of a frequency analysis at which each of the operating hardware 101 is triggered to perform different flicker displays, wherein the flicker frequency of each of the light controlled components 102 is used to feed back a frequency at which the corresponding operating hardware 101 is triggered. Therefore, the use frequency is identified by a simple flicker frequency, so that users may intuitively understand their operation preferences. In an embodiment of the present invention, the light controlled component 102 is a light component, each light component corresponds to an operating hardware 101 (a button), and the flicker frequency of the light component corresponds to the use frequency of the corresponding operating hardware 101. Optionally, in the process of performing different flicker displays, changes of an external ambient light is sensed, and the brightness and/or the color of the light controlled component 102 are automatically adjusted to meet the needs of human eyes. Therefore, when flicker displays of the light controlled component 102 are preformed, the brightness and/or color should be adjusted to ensure the user’s eye comfort and avoid flickering during the identification process to harm the human eye. Optionally, with reference to FIG. 16, FIG. 16 is a second flow chart of a dynamic identification method of a game device according to an embodiment of the present invention, and the dynamic identification method of a game device further includes a step S4.

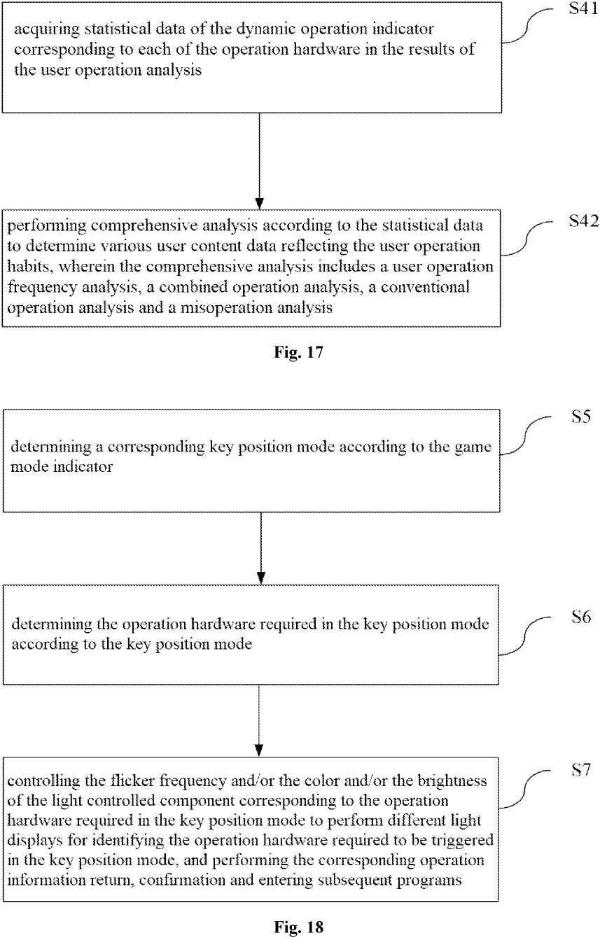

In the step S4, a terminal is controlled to perform further comprehensive data analysis on the dynamic operation indicators of all the operating hardware 101, a plurality of user content data reflecting user operation habits and displaying is determined and the various user content data is displayed on a display component of the terminal, according to the results of the user operation analysis. Therefore, the terminal performs further comprehensive data analysis on dynamic operation indicators, and uses the rapidity and accuracy of data processing by the terminal to comprehensively analyze all dynamic operation indicators, so as to find a variety of user content data reflecting the user operation habits through data processing, and display it to facilitate the user self-examination. Optionally, with reference to FIG. 17, FIG. 17 is a flow chart of a terminal analysis according to an embodiment of the present invention, and the step S4 specifically includes steps S41 to S42.

In the step S41, statistical data of the dynamic operation indicator corresponding to each of the operating hardware 101 is acquired in the results of the user operation analysis. Therefore, the statistical data is effectively acquired to ensure the comprehensiveness and reliability of the data. In the step S42, comprehensive analysis is performed according to the statistical data to determine the various user content data reflecting the user operation habits, wherein the comprehensive analysis includes a user operation frequency analysis, a combined operation analysis, a conventional operation analysis and a misoperation analysis. Therefore, statistics of dynamic operation indicators are processed through methods such as key data extraction, similar data accumulation, data comparison, interception, and filtering, so that the terminal software presents the corresponding analysis results for allowing users to self-check, and also facilitating product tuning while enhancing the product experience effect.

Optionally, with reference to FIG. 18, FIG. 18 is a third flow chart of a dynamic identification method of a game device according to an embodiment of the present invention, the operation signal further includes the game mode indicator selected by the user by triggering the operating hardware 101, and the above dynamic identification method of a game device further includes steps S5 to S7.

In the step S5, a corresponding key position mode is determined according to the game mode indicator. Therefore, through the game mode indicator input by the user, the key position mode corresponding to the game mode required by the current user is effectively determined. In the step S6, the operating hardware 101 required in the key position mode is determined according to the key position mode. Therefore, the operating hardware 101 required to be triggered in the key position mode is effectively determined. In the step S7, the flicker frequency and/or the color and/or the brightness of the light controlled component 102 corresponding to the operating hardware 101 required in the key position mode is controlled to perform different light displays for identifying the operating hardware 101 required to be triggered in the key position mode, and performing the corresponding operation information return, confirmation and entering subsequent programs. Therefore, through the game mode indicator, the key position mode corresponding to the game mode required by the current user is effectively determined, so that the key position mode and corresponding function are displayed under the control of key position display signals, which is convenient for the user operation.

In a specific embodiment of the present invention, the game mode indicator includes a first game mode indicator and a second game mode indicator. In a game A, correspondingly, there is the first game mode indicator, wherein a button A is “up”, a button B is “down”, a button C is “left”, and a button D is “right”; in a game B, correspondingly, there is the second game mode indicator, wherein a button E is “up”, a button F is “down”, a button G is “left”, and a button H is “right”. If the user chooses the game A, the input is the first game mode indicator, then the key position mode of the game A is determined according to the first game mode indicator, and the position and function of the buttons A, B, C, and D are identified by means such as light identification and electronic screen identification. Similarly, if the user chooses the game B, the input is the second game mode indicator, then the key position mode of the game B is determined according to the second game mode indicator, and the position and function of the buttons E, F, G, and H are identified by means such as light identification and electronic screen identification.

Optionally, the operation signal further includes a confirmation storage instruction formed by the user by triggering the operating hardware 101, the above dynamic identification method of a game device further including:

user preference operations are entered and stored according to the confirmation storage instruction, wherein the user preference operations include a key layout formed by triggering the operating hardware 101 after the confirmation storage instruction is issued by the user, and/or a key layout set by the display component of the terminal after the confirm storage instruction is issued by the user. In the present invention, by storing instructions, the preferred key layout of the user is effectively entered and archived so that the user may use the default extraction again, which further enhances the flexibility of use. Specifically, in the present invention, the storage may be performed by the device software of the terminal to extract the corresponding buttons and layout according to different game devices, and the user may switch and define buttons according to the default layout for saving them after the configuration is completed. Then, the user operates the game device again to use the custom button layout. When the device connected to the terminal is in communication, the data interface is activated. After the user configuration is saved, the configuration item is stored through the data interface and enabled.

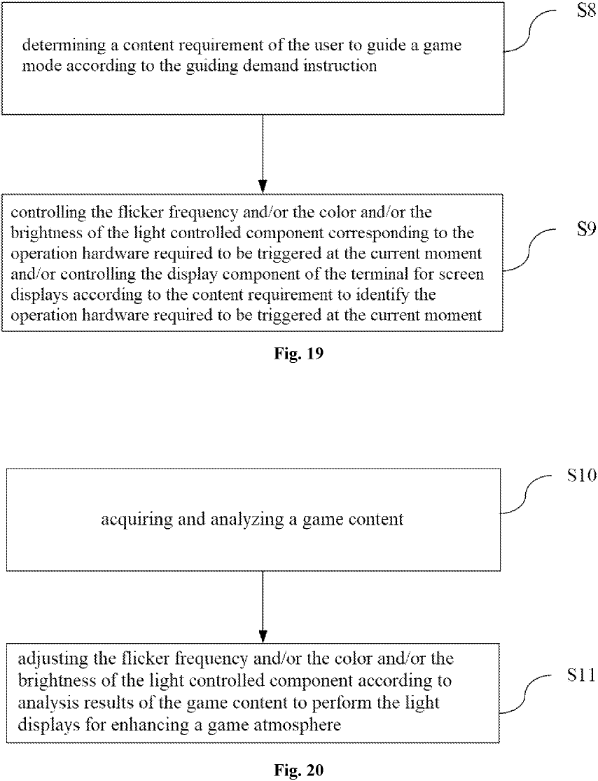

Optionally, with reference to FIG. 19, FIG. 19 is a fourth flow chart of a dynamic identification method of a game device according to an embodiment of the present invention, the operation signal further includes a guiding demand instruction formed by the user by triggering the operating hardware 101, and the above dynamic identification method of a game device further includes steps S8 to S9.

In the step S8, a content requirement of the user is determined to guide a game mode according to the guiding demand instruction. Therefore, the content requirements of the game required to be guided by the user may be effectively determined. In the step S9, the flicker frequency and/or the color and/or the brightness of the light controlled component 102 corresponding to the operating hardware 101 required to be triggered is controlled at the current moment and/or the display component of the terminal for screen displays according to the content requirement is controlled to identify the operating hardware 101 required to be triggered at the current moment. Therefore, with combination of the game content by identifying the operating hardware 101 required to be triggered at the current moment, game teaching and guidance are performed for the novice, so that the user may enter the game faster to increase the playability of the game and nurture novices. Specifically, after entering the game operation guide step, the game device may perform data extraction through the game and interface while synchronizing the guide step instruction to be transmitted by a data port of the terminal, then the light circuit is controlled by the light controlled component 102 to control the light unit by pulse width modulation and voltage for flashing synchronously with the terminal guidance step to achieve the purpose of auxiliary prompt operation; when the user controls the corresponding button or other hardware, the instruction is fed back to the data communication port with voltage modulation for being transmitted to the terminal device; the above process is considered as a successful feedback after completing the guidelines once, then proceeding to the next step. If the user does not perform the corresponding operations of pressing any keys, a misoperation record is formed and stored in the processor for misoperation analysis.

Optionally, with reference to FIG. 20, FIG. 20 is a fifth flow chart of a dynamic identification method of a game device according to an embodiment of the present invention, and the dynamic identification method of a game device further includes steps S10 to S11.

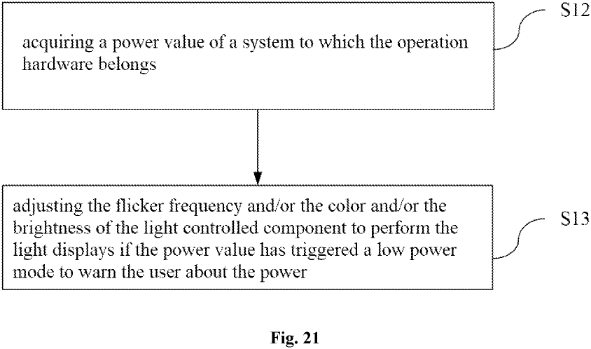

In the step S10, a game content is acquired and analyzed. In the step S11, the flicker frequency and/or the color and/or the brightness of the light controlled component 102 is adjusted according to analysis results of the game content to perform the light displays for enhancing a game atmosphere. Therefore, by adjusting the flicker frequency and/or color and/or brightness of the light controlled component 102 for display, the atmosphere of the game is ensured and the user experience is enhanced. Optionally, with reference to FIG. 21, FIG. 21 is a sixth flow chart of a dynamic identification method of a game device according to an embodiment of the present invention, and the dynamic identification method of a game device further includes steps S12 to S13.

In the step S12, a power value of a system to which the operating hardware 101 belongs is acquired. In the step S13, the flicker frequency and/or the color and/or the brightness of the light controlled component 102 is adjusted to perform the light displays if the power value has triggered a low power mode to warn the user about the power. Therefore, by adjusting the flicker frequency and/or color and/or brightness of the light controlled component 102 for display, the power is reminded to avoid the system working under low power and ensure the safe operation of the system.

Optionally, the above dynamic identification method of a game device further includes: when it is recognized that the user game time has exceeded a specified time, the user is controlled to shut down forcibly or the light controlled component 102 is controlled to send a timeout reminder signal. Therefore, the corresponding timeout reminder is performed. For example, a red light warning is issued through the light component in the light controlled component 102, or the user is reminded that the game time has expired through the display screen of the terminal. Therefore, a safe and healthy way of playing games is ensured for the user.

For the dynamic identification method of a game device provided by the present invention, the operation of the user is recorded and analyzed to understand the operation method of the user, and using the display of the light controlled component 102 for intuitive presentation allows the user to more clearly understand their own operation mode, so as to further optimize and improve the convenience of the user.

An embodiment of a further aspect of the present invention provides a computer readable storage medium stored with computer programs, which realize, when read and executed by a processor, the above dynamic identification method. The computer readable storage medium provided by the present invention records and analyzes the operation of the user to understand the operation method of the user, and uses the display of the light controlled component 102 for intuitive presentation allows the user to more clearly understand their own operation mode, so as to further optimize and improve the convenience of the user.

Although the present invention has been disclosed through the above embodiments, the scope of the present invention is not limited thereto. Without departing from the concept of the present invention, the above components can be replaced with similar or equivalent elements understood by those skilled in the art.

What is claimed is:

1. A controller for function switching and dynamic identification switching, comprising:
a switch circuit, a master circuit and a switching circuit, wherein the switch circuit is electrically connected to the master circuit, and the switching circuit is electrically connected to the master circuit; the switching circuit comprises a function realization component and a light controlled component, the function realization component is electrically connected to the master circuit for function realization, and the light controlled component is electrically connected to the master circuit for light conversion.

2. The controller for function switching and dynamic identification switching according to claim 1, wherein the switch circuit comprises a power supply and a plurality of switch elements for forming a plurality of high-level and low-level input signals, wherein the plurality of switch elements are electrically connected to the power supply respectively, and the plurality of switch elements are electrically connected to the master circuit respectively.

3. The controller for function switching and dynamic identification switching according to claim 1, wherein the master circuit comprises a micro control unit, the micro control unit is electrically connected to the switch circuit through input signal pins, and the micro control unit is electrically connected to the switching circuit through output signal pins.

4. The controller for function switching and dynamic identification switching according to claim 3, wherein the switch circuit comprises a plurality of switch elements, and the micro control unit is connected to the plurality of switch elements through the input signal pins for receiving the plurality of high-level and low-level input signals formed by the plurality of switch elements.

5. The controller for function switching and dynamic identification switching according to claim 3, wherein the function realization component comprises a plurality of operation elements, and the micro control unit is connected to the plurality of operation elements through the input signal pins for outputting the plurality of high-level and low-level input signals to the plurality of operation elements.

6. The controller for function switching and dynamic identification switching according to claim 3, wherein the light controlled component comprises a plurality of light elements, and the micro control unit is connected to the plurality of light elements through the input signal pins for outputting the plurality of high-level and low-level input signals to the plurality of light elements.

7. The controller for function switching and dynamic identification switching according to claim 1, further comprising:
a voice control circuit, the voice control circuit comprising a voice control component, the voice control component being electrically connected to the master circuit.

8. The controller for function switching and dynamic identification switching according to claim 1, further comprising:
a blue-tooth circuit, the blue-tooth circuit comprising a blue-tooth chip, the blue-tooth chip being electrically connected to the master circuit.

9. The controller for function switching and dynamic identification switching according to claim 8, wherein the master circuit comprises a micro control unit, and the micro control unit is electrically connected to different blue-tooth signal output pins of the blue-tooth chip through a plurality of input signal pins.

10. A dynamic identification method, applied to the controller for function switching and dynamic identification switching according to claim 1, the dynamic identification method comprising:
acquiring an operation signal, the operation signal comprising dynamic operation indicators formed by a user triggering operating hardware through a plurality of dynamic operations, the dynamic operation indicators comprising a frequency, a timing and a strength at which each of the operating hardware is triggered;
recording and counting the dynamic operation indicators for performing a user operation analysis;
controlling a flicker frequency and/or a color and/or a brightness of the light controlled components corresponding to the operating hardware according to results of the user operation analysis to perform different light displays for feeding back the dynamic operating indicators corresponding to each of the operating hardware.

11. The dynamic identification method according to claim 10, wherein the results of the user operation analysis comprise an analysis result of the frequency at which each of the operating hardware is triggered, and the step of controlling the flicker frequency and/or the color and/or the brightness of the light controlled components corresponding to the operating hardware according to results of the user operation analysis to perform different light displays comprising:
controlling the flicker frequency of the light controlled components corresponding to the operating hardware according to the analysis result of the frequency at which each of the operating hardware is triggered to perform different flicker displays, wherein the flicker frequency of each of the light controlled components is used to feed back the frequency at which the corresponding operating hardware is triggered.

12. The dynamic identification method according to claim 11, wherein during the process of performing different flicker displays, changes of an external ambient light are sensed, and the brightness and/or the color of the light controlled components are automatically adjusted to meet requirements of human eyes.

13. The dynamic identification method according to claim 10, further comprising:
controlling a terminal to perform further comprehensive data analysis on the dynamic operation indicators of all the operating hardware and determining a plurality of user content data reflecting user operation habits according to the results of the user operation analysis, and displaying the plurality of user content data on a display component of the terminal.

14. The dynamic identification method according to claim 13, wherein the step of controlling a terminal to perform further comprehensive data analysis on the dynamic operation indicators of all the operating hardware and determining a plurality of user content data reflecting user operation habits according to the results of the user operation analysis comprises:
acquiring statistical data of the dynamic operation indicators corresponding to each of the operating hardware in the results of the user operation analysis; and
performing comprehensive analysis according to the statistical data to determine the plurality of user content data reflecting the user operation habits, wherein the comprehensive analysis comprises a user operation frequency analysis, a combined operation analysis, a conventional operation analysis and a misoperation analysis.

15. The dynamic identification method according to claim 10, wherein the operation signal further comprises a game mode indicator selected by the user by triggering the operating hardware, the dynamic identification method further comprising:
determining a corresponding key position mode according to the game mode indicator;
determining the operating hardware required in the key position mode according to the key position mode; and
controlling the flicker frequency and/or the color and/or the brightness of the light controlled components corresponding to the operating hardware required in the key position mode to perform different light displays for identifying the operating hardware required to be triggered in the key position mode.

16. The dynamic identification method according to claim 10, wherein the operation signal further comprises a confirmation storage instruction formed by the user by triggering the operating hardware, the dynamic identification method further comprising:
entering and storing user preference operations according to the confirmation storage instruction, wherein the user preference operations comprise a key layout formed by triggering the operating hardware after the confirmation storage instruction is issued by the user, and/or a key layout set by the display component of the terminal after the confirm storage instruction is issued by the user.

17. The dynamic identification method according to claim 10, wherein the operation signal further comprises a guiding demand instruction formed by the user by triggering the operating hardware, the dynamic identification method further comprising:
determining a content requirement of the user to guide a game mode according to the guiding demand instruction; and
controlling the flicker frequency and/or the color and/or the brightness of the light controlled components corresponding to the operating hardware required to be triggered at a current moment and/or controlling the display component of the terminal for screen displays according to the content requirement to identify the operating hardware required to be triggered at the current moment, and performing corresponding operation information return, confirmation and entering subsequent programs.

18. The dynamic identification method according to claim 10, further comprising:
acquiring and analyzing a game content; and
adjusting the flicker frequency and/or the color and/or the brightness of the light controlled component according to analysis results of the game content to perform the light displays for enhancing a game atmosphere.

19. The dynamic identification method according to claim 10, further comprising:
acquiring a power value of a system to which the operating hardware belongs;
adjusting the flicker frequency and/or the color and/or the brightness of the light controlled component to perform the light displays if the power value has triggered a low power mode to warn the user about the power.

20. A computer-readable storage medium storing one or more instructions which, when executed by one or more processors of an electronic device, executes the dynamic identification method applied to the controller for function switching and dynamic identification switching according to claim 10, the method comprising:
acquiring an operation signal, the operation signal comprising dynamic operation indicators formed by a user triggering operating hardware through a plurality of dynamic operations, the dynamic operation indicators comprising a frequency, a timing and a strength at which each of the operating hardware is triggered;
recording and counting the dynamic operation indicators for performing a user operation analysis; and
controlling a flicker frequency and/or a color and/or a brightness of the light controlled components corresponding to the operating hardware according to results of the user operation analysis to perform different light displays for feeding back the dynamic operating indicators corresponding to each of the operating hardware.
